(19) United States
(12) Patent Application Publication
(10) Pub. No.: US 2026/0307130 A1
(43) Pub. Date: Oct. 8, 2026

(54) Coin Cell Case

(71) Applicant: WiLDCAT DISCOVERY TECHNOLOGIES, INC., San Diego, CA (US)

(72) Inventors: Deidre Strand, San Diego, CA (US); Justin Dutton, San Diego, CA (US); Stacy Redmond, San Diego, CA (US); Ye Zhu, San Diego, CA (US)

(21) Appl. No.: 19/482,280

(22) PCT Filed: May 29, 2024
(86) PCT No.: PCT/US2024/031400

§ 371 Date: Nov. 7, 2025

Related U.S. Application Data
(60) Provisional application No. 63/470,247, filed on Jun. 1, 2023.

(51) Int. Cl. B21D 22/02; H01M 50/119; H01M 50/124

(52) U.S. Cl. CPC B21D 22/02; H01M 50/119; H01M 50/124

(57) ABSTRACT

Coin cell case components may be made by a method comprising stamping a bimetallic sheet comprised of stainless steel fused to aluminum to form a coin cell case component, the bimetallic sheet being formed by a method comprising pressing a stainless steel sheet and an aluminum sheet in the absence of annealing after pressing. Coin cells comprised of a positive or negative case are suitable for high voltage batteries (≥4.3V) such as those having a cathode containing a disordered rock salt and/or a liquid electrolyte having a lithium salt and a solvent.

### FIELD

The present invention is in the field of battery technology.

### BACKGROUND

Coin cells are used in many consumer applications and for electrochemical evaluation of materials, including variations on cathodes, anodes, and electrolytes. The coin cells comprise a positive and negative lid as well as other battery components. Lithium metal oxides have been used to formulate cathode materials for lithium ion batteries. The cathodes are derived from a few basic crystallographic structure types, such as spinels, olivines, and layered oxide structures. The layered oxide structures have included lithium-excess type structures, where additional lithium is present in the structure. Typical materials of construction for the positive case are various stainless steels (e.g., 316L) which are subject to corrosion under some conditions which negatively affects the cell performance.

So-called “aluminum clad” positive cases are available commercially in which the case is coated with aluminum which prevents corrosion of the stainless steel. However, these products are produced by sputter coating aluminum metal onto the stainless steel surface. The resulting coating may be nonuniform, particularly on the sidewalls of the case, and can often have pinholes. This results in poor electrochemical results when tested at higher voltages and/or with corrosive electrolytes such as typically found when using a high energy cathode such as an oxide or phosphate having one or more of Cu, Co, and Ni having a crystal structure comprised of one or more of a disordered rock salt, layered, spinel and olivine that operate at higher voltages (e.g., at least 4.3 or 4.5 volts).

Aluminum electroplated coin cells have been commercially available by electroplating processes such as described in U.S. Pat. No. 7,250,102. The process is multi-stepped including pretreatments and interlayers. The process can result in coated cases with good electrochemical performance. However, the yield of parts with good, blemish-free coatings can be quite low (less than ~50%). Likewise, the process is expensive due the multiple steps, usage of organic solvents, and requirement to be air-free.

Higher voltage cathodes have tended to be operated under more severe conditions than typical layered oxides resulting in coin cell cases requiring better corrosion resistance made by a high yield cost effective method. It would be desirable to provide a coin cell battery comprised of a higher voltage cathode that avoids corrosion problems and other desirable attributes such as safer batteries.

### BRIEF SUMMARY

It has been discovered that coin cells components (e.g., positive case and negative case) may be manufactured from a bimetallic stainless steel/aluminum sheet by flanging the sheet to form the coin cell components, the bimetallic sheet being formed by pressing in the absence of annealing. Coin cells having desired electrochemical performance may be produced by employing coin cell components such as a positive case and negative case formed by stamping (flanging) a bimetallic stainless steel/aluminum sheet that had been formed by pressing (clad sheet). They are are particularly useful with lithium ion electrolytes that are corrosive, such as those that contain a lithium salt (e.g., lithium bis(fluorosulfonyl)imide (LiFSI)). Under these conditions, the stainless steel of the cases may have accentuated corrosion resulting in excess residual current in the cell as well as corrosion by-products which are detrimental to cell performance.

A first illustration is a method to form a coin cell case component comprising stamping a bimetallic sheet comprised of stainless steel fused to aluminum to form a coin cell case component, the bimetallic sheet being formed by pressing a stainless steel sheet and an aluminum sheet in the absence of annealing after pressing. It has been discovered that the bimetallic sheet may be formed in the absence of annealing after being formed without undesirable warpage during the formation of the coin cell (flanging).

Another illustration is a coin cell comprised of a coin cell component of the first illustration and a cathode comprised of a disordered rock salt. A further illustration is a coin cell comprised of the coin cell component of the first illustration and an electrolyte comprised of a lithium salt (e.g., lithium bis(fluorosulfonyl)imide salt).

### BRIEF DESCRIPTION OF THE DRAWINGS

The FIGURE shows the capacity retention v. cycles of coin cells of this invention and not of this invention.

### DETAILED DESCRIPTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range 1 to 3 includes the values 1 and 3 as well as the intermediate values.

The method to form a coin cell component comprises stamping a bimetallic sheet comprised of stainless steel and aluminum fused together by pressing a stainless steel sheet and aluminum sheet. The pressing to form the bimetallic sheet may be any suitable such as those known in the art. Illustratively, the pressing may be by uniaxial pressing or by roll pressing with or without application of heat other than that created by the pressing itself. An exemplary method that may be suitable includes those described in KR10037650, but to reiterate it is desirable that the pressing is by cold working (i.e., in the absence of the application of external heating).

The pressing pressure may be any suitable to realize a reduction of the stainless steel sheet thickness that induces minimal internal stresses in the stainless steel which can cause warpage when stamping the coin cell case components. This typically means the the thickness of the stainless steel layer of the bimetallic sheet is 0.5, 0.6 or 0.7 to 0.9 or 0.85 times as thick as the stainless steel sheet used to form the bimetallic sheet. The reduction in the aluminum sheet may be commensurate with the stainless steel sheet, but in many instances the ductility of the aluminum sheet may be more ductile than the stainless steel sheet and as such may undergo greater reduction in thickness such as a factor of 1.1, 1.2, 1.3, 1.4 or 1.5, or to 10 or 5 times the reduction in thickness of the stainless steel sheet. Generally, the thickness aluminum layer of the bimetallic sheet is substantially less than the bimetallic sheet's stainless steel layer with the aluminum layer typically being about 0.01, 0.02, or 0.04 to 0.25 times the stainless steel layer thickness.

It has been discovered that cold working to form the bimetallic sheet is desirable and further annealing after forming the bimetallic sheet is not necessary. That is, annealing may impart undesirable stresses due the temperature being limited by the melting temperature of the aluminum and as such the stress state of the aluminum may be altered substantially whereas the stainless steel stress state may not be. This alteration of the stress state of the bimetallic sheet may cause undesirable warpage when forming the coin cell case component.

It has also been discovered that too little reduction of the stainless steel sheet's thickness may not realize the necessary fusing of the aluminum to the stainless steel, where flaws may occur more readily upon stamping the bimetallic sheet into coin cell case component. Likewise, too much deformation when forming the bimetallic sheet may cause excessive embrittlement of the stainless steel also causing flaws during stamping to form the coin cell case component.

The bimetallic sheet may be any thickness useful to make a coin cell case component such as common in the art. Illustratively, the thickness may be from about 100, 150 or 200 micrometers to 500, 400, 300 or 250 micrometers thick.

The stainless steel may be any useful for forming a coin cell case component such as those known in the art. Exemplary stainless steel alloys may include AISI (American Iron and Steel Institute stainless steels such as those described in Table 16.24 of Eshbach's Handbook of Engineering Fundamentals, 4^{th} Ed., John Wiley and Sons, Inc., 1990. The stainless steel, for example, may be austenitic, martensitic, or ferritic. Each type may be more applicable depending on the circumstances (e.g., corrosion resistance in a particular application).

The aluminum sheet may be comprised of aluminum or alloy thereof. Alloys of aluminum may be those having an aluminum content of at least 99.5%.

The stamping of the bimetallic sheet may be performed by any suitable stamping/ironing technique such as those known in the art such as described in EP 0762519 and U.S. Pat. Nos. 3,820,368; 4,457,150; 5,787,752; and 6,485,863.

The coin cell may have any other components useful to make a coin cell with examples being described in U.S. Pat. No. 4,246,326 and U.S. Pub. No. 2013/0143104. The cell components may include a battery lid, a cathode, an anode, a separator, or any combination thereof. In an illustration, the coin cell is comprised of a cathode comprised of an oxide or phosphate in which the cathode has an operating voltage of at least 4.3 or 4.5 volts. Examples of such cathodes include those comprised of one of more of Cu, Co, Ni, and Mn and may be a layer oxide, olivine, spinel or disordered rock salt oxide.

The coin cell may be comprised of a liquid electrolyte. The liquid electrolyte is comprised of a solvent and a salt (e.g., lithium salt). This electrolyte solution may include one or more solvents such as those known in the art for making lithium ion batteries such as those described by U.S. Pat. Nos. 10,367,232 and 11,094,966 each incorporated herein by reference.

The electrolyte salt and/or lithium salt may include first and second salts that are different from each other. The electrolyte salt and/or the lithium salt may include one or more of (oxalato)borate (LiBOB), lithium bis(pentafluoroethylsulfonyl)imide (Li-BETI), lithium bis(fluorosulfonyl)imide (LiFSI), lithium tetrafluoroborate (LiBF₄), lithium trifluoromethanesulfonate (LiTriflate), lithium hexafluoroarsenate (LiAsF₆), lithium bis(trifluoromethanesulfonimide) (LiTFSI), and lithium hexafluoro-phosphate (LiPF₆), lithium nitrate (LiNO₃), LiN(SO₂CF₃)₂, LiN(SO₂F)₂, LiCF₃SO₃, LiClO₄, lithium difluoro oxalato borate anion (LiDFOB), LiI, LiBr, LiCl, LiOH, LiSO₄, or any combination thereof. The salt concentration may be any useful such as 0.1M to 5M.

### EXAMPLES

Foils of 316L stainless steel and 1100 aluminum alloy are coldworked to a 30% reduction of the thickness of the starting stainless steel. The final bimetallic sheet has thickness of about 0.25 mm stainless steel and about 12 micrometers aluminum. Mechanical testing is performed on the resulting metal bilayer, demonstrating a yield strength of 125.6 Kpsi, an ultimate tensile strength of 141.0 Kpsi, and elongation of 11.9%. This is indicative of a 30% reduction in the stainless steel. The sheet is stamped into coin cell components (positive and negative case).

Once the parts are stamped, they are washed in solvents such as water, acetone, isopropyl alcohol, hexane, trichloroethylene or combinations thereof.

Electrochemical testing is performed on assembled coin cells. The cells are formed in a high purity argon filled glove box (M-Braun, O2 and humidity content<0.1 ppm). For the cathode, a commercial high Ni NMC (Ni content≥80%, referred to herein as NMC811)) active material is mixed with polyvinylidene fluoride (PVDF), carbon black powder, and liquid 1-methyl-2-pyrolidinone (NMP) to form a slurry. The resulting slurry is deposited on an aluminum current collector and dried to form a composite cathode film. For the anode, a commercial graphite active material is mixed with Carboxymethyl cellulose binder (CMC) and Styrene-Butadiene Rubber (SBR) Binder, carbon black powder, and water to form a slurry. The resulting slurry is deposited on a copper current collector and dried to form a composite anode film. Each battery cell includes the composite cathode film, a polypropylene separator, and the composite anode film. The cell is filled with a liquid electrolyte consisting of 10 weight % lithium hexafluorophosphate, 6 weight % LiFSI in ethylene carbonate/ethyl methyl carbonate/dimethyl carbonate (20/16/48 by volume) with 2 weight % vinylene carbonate and 0.5 weight % tetravinylsilane.

The battery cell is sealed and initially cycled at ambient temperature using 0.1 C charge to upper cutoff voltage 4.2V followed by constant voltage hold until the current drops to 0.05 C and then discharges to 2.8V using 0.1 C constant current. The cycle is repeated one more time prior to faster rate cycling (0.5 C charging to 4.05V then 0.33 C charge to 4.2V; 0.5 C discharge to 2.8V) at 55° C. for subsequent cycles. These example coin cells (Al-clad) are compared to coin cells “control” wherein the positive and negative cases are high quality Alumiplate electroplated aluminum (“Al-plate) case that have been inspected.

Because the dimensions of the case are critical to achieving good crimping to provide a tight seal, the weights of the cells were recorded before and after cycling to ensure no electrolyte loss. Commercially available aluminum electroplated cases had an average weight loss of 6.9%, while the Al-clad cases had an average weight loss of 8.1% which was not significantly different from the control indicating that the stamped cases sealed similarly to the control. Likewise, cell resistance is measured at 50% state of charge with a 3 C pulse as function of cycle life with both Al-clad and Al-plate coin cells essentially displaying the same resistance at each cycle.

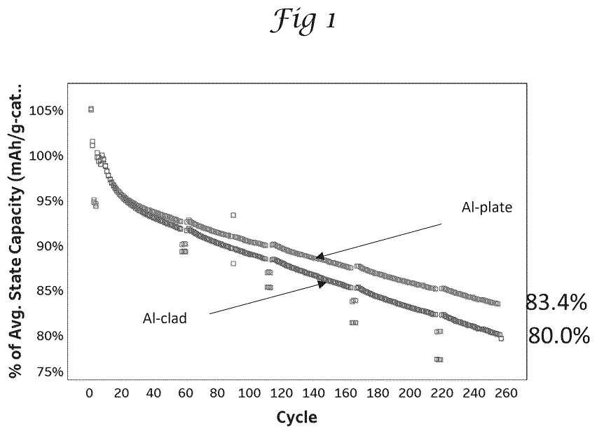

The average of the example and control coin cells capacity retention v. cycles is shown in FIG. 1. While the capacity retention is slightly less for the Al-clad cases, performance is acceptable for a highly economically efficient fabrication method. This electrolyte is very corrosive, so represents a “worst case” scenario. Likewise, cell resistance is measured at 50% state of charge with a 3 C pulse as function of cycle life with both Al-clad and Al-plate coin cells with the cells essentially displaying the same resistance at each cycle.

What is claimed is:

1. A method to form a coin cell case component comprising stamping a bimetallic sheet comprised of stainless steel fused to aluminum to form a coin cell case component, the bimetallic sheet being formed by a method comprising pressing a stainless steel sheet and an aluminum sheet in the absence of annealing after pressing, wherein the stainless steel of the bimetallic sheet has a thickness of 150 to 300 micrometers and the aluminum of the bimetallic sheet has a thickness of 5 to 25 micrometers.

2. (canceled)

3. (canceled)

4. The method of claim 1, wherein the thickness of the stainless steel of the bimetallic sheet has a thickness that is 0.5 to 0.9 times the stainless steel sheet's thickness.

5. The method of claim 4, wherein the thickness of the stainless steel sheet is 15% to 30% greater than the thickness of the stainless steel of the bimetallic sheet.

6. The method of claim 1, wherein the pressing is in the absence of externally supplied heating.

7. A coin cell comprised of the coin cell case component of claim 1.

8. The coin cell of claim 7, wherein the coin cell is comprised of a cathode having an operating voltage of at least 4.3 volts.

9. The coin cell of claim 8, wherein the cathode is comprised of one or more of Cu, Ni, Co, and Mn.

10. The coin cell of claim 7, wherein the coin cell is comprised of an electrolyte having a lithium salt.

11. The coin cell of claim 10, wherein the lithium salt is comprised of lithium bis(fluorosulfonyl)imide.

12. A method to form a coin cell case component comprising stamping a bimetallic sheet comprised of stainless steel fused to aluminum to form a coin cell case component, the bimetallic sheet being formed by a method comprising pressing a stainless steel sheet and an aluminum sheet in the absence of annealing after pressing, wherein the thickness of the stainless steel of the bimetallic sheet has a thickness that is 0.5 to 0.9 times the stainless steel sheet's thickness.

13. A method to form a coin cell case component comprising stamping a bimetallic sheet comprised of stainless steel fused to aluminum to form a coin cell case component, the bimetallic sheet being formed by a method comprising pressing a stainless steel sheet and an aluminum sheet in the absence of annealing after pressing, wherein the thickness of the stainless steel sheet is 15% to 30% greater than the thickness of the stainless steel of the bimetallic sheet.

14. The method of claim 12, wherein the pressing is in the absence of externally supplied heating.

15. The method of claim 13, wherein the pressing is in the absence of externally supplied heating.

16. A coin cell comprised of the coin cell case component of claim 14.

17. The coin cell of claim 16, wherein the coin cell is comprised of a cathode having an operating voltage of at least 4.3 volts.

18. A coin cell comprised of the coin cell case component of claim 15.

19. The coin cell of claim 18, wherein the coin cell is comprised of a cathode having an operating voltage of at least 4.3 volts.
